(19) United States
(12) Patent Application Publication
(10) Pub. No.: US 2025/0086150 A1
(43) Pub. Date: Mar. 13, 2025

(54) System and Method for Automated Data Deduplication Data Management

(71) Applicant: Toshiba TEC Kabushiki Kaisha, Shinagawa-ku (JP)

(72) Inventor: Adam HINKLE, Lake Forest, CA (US)

(21) Appl. No.: 18/367,633

(22) Filed: Sep. 13, 2023

(51) Int. Cl. G06F 16/215; G06F 16/21

(52) U.S. Cl. CPC G06F 16/215; G06F 16/219

(57) ABSTRACT

A system and method for data automated management, storage and retrieval of data runs on a cloud computing platform. Storage space is saved by implementation of data deduplication using a parent data storage and one or more child data storage. An application calculates a checksum on incoming data blobs into a child storage. Incoming data is stored in the parent storage with the associated checksum when there is no matching checksum. The incoming data is deleted from the child storage and replaced with an associated checksum label. Additional applications provide for automated reduplication, storage, retrieval and deletion of data.

### TECHNICAL FIELD OF THE INVENTION

This application relates generally to data storage and retrieval management. The application relates more specifically to an automated system for efficiently storing and distributing binary large objects for multiple networked data devices.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used. MFPs, as well as other network devices, require storage and access of data files. In the case of MFPs, data files may include electronic documents such as text files, word processing documents, bitmapped images, and the like. Other devices may include large files, such as multimedia files, which can be quite large.

The age of digital information has led to exponential increases in the quantity of data which businesses collect and rely upon. Many software applications rely on the ability to read and write data into storage. The Internet of Things (IoT) is a network of interconnected physical devices, objects, and systems that are embedded with sensors, software, and other technologies to collect and exchange data over the internet. These devices can range from everyday objects like household appliances and wearable devices to industrial equipment and vehicles. IoT services tend to have large amounts of data transferring between devices and servers. Some of this data may be stored in a database, and some of this data may need to be stored as binary data in a cloud-based file storage.

MFPs, as well as other network devices, require storage and access of data files. In the case of MFPs, data files may include electronic documents such as text files, word processing documents, bitmapped images, and the like. Other devices may include large files, such as multimedia files, which can be quite large.

Larger data files are referred to as binary large objects (blobs). Blob storage for many network devices can require significant storage space which can be expensive to assemble and maintain. Data storage can become expensive; therefore it is advisable for businesses to manage the size of their growing storage requirements.

### BRIEF DESCRIPTION OF THE DRAWINGS

Various embodiments will become better understood with regard to the following description, appended claims and accompanying drawings wherein:

FIG. 1 is an example embodiment of a system for automated data deduplication data management;

FIG. 2 is an example embodiment of a class diagram for an Azure data deduplication blob storage client;

FIG. 3 is an example embodiment of a digital device system;

FIG. 4 illustrates a flowchart of an example embodiment of a data deduplication system;

FIG. 5 illustrates a flowchart of an example embodiment of a data reduplication system;

FIG. 6 illustrates a flow diagram of an example embodiment of a data upload system;

FIG. 7 illustrates a flow diagram of an example embodiment of a data retrieval system; and

FIG. 8 illustrates a flow diagram of an example embodiment of a data deletion system.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Example embodiments herein provide an automated system for data storage and retrieval employing data deduplication. Data deduplication is employed in data storage systems or accounts to efficiently manage and store data by eliminating duplicate copies. This is analogous to tidying up a digital library with repeated books, optimizing space, and improving performance. The following is a breakdown of the process:

Chunking Data: By way of example, one may consider data as a bookshelf full of books. Deduplication starts by breaking down these books into smaller, manageable segments, like dividing a book into individual paragraphs.

Generating Unique Identifiers: Each segment, or “chunk,” gets a special identifier known as a hash value. This is analogous to giving each paragraph a unique code based on its content. This hash value is created using a mathematical algorithm that converts the content of the chunk into a fixed-size string of characters.

Comparing Hash Values: These hash values are compared to a list of existing hash values stored in a database. This may be analogized to a database as a catalog of all the unique paragraphs you've encountered before.

Detecting Duplicates: If a hash value matches one already in the database, it indicates that the content is not new, you've already read that paragraph. In terms of data, it means the chunk already exists in the storage.

Skipping Duplicate Storage: Instead of storing the duplicate chunk again, the system creates a reference to the existing chunk. This is analogous to a bookmark that points to the paragraph you've read elsewhere in a different book.

Storing Only Unique Chunks: For new chunks with hash values that don't match anything in the database, they are stored as is. These are the parts of the story that have not yet been encountered.

Preserving Metadata: In addition to the hash values, some extra information about the chunks is also stored. This metadata includes details like where the chunk came from, when it was created, and its relationship to other chunks.

Retrieving Original Data: When access to data is needed, the system uses the hash values and metadata to reconstruct the original content, analogous to piecing together parts of the story using the bookmarks and additional notes you've collected.

Different approaches to deduplication can be used, depending on the level of detail desired for comparison. One can look at entire books, individual chapters, paragraphs, or even sentences. A goal is to strike a balance between saving storage space and the computational effort required for comparison. By efficiently managing duplicates, data deduplication minimizes storage costs, optimizes data transfer, and ensures smoother data management.

Moving towards data deduplication is not a non-trivial process for a business to undertake. Converting a storage or multiple storages to a data deduplicated state must be done carefully. Additionally, to convert a working application which relies on a basic duplicated cloud storage into one which uses a deduplicated cloud storage involves many technical considerations. The full process comes at the cost of upfront time and development resources which may be a prohibitive barrier to many businesses.

Example embodiments herein describe a system and method for automating a data file management system that includes data deduplication, data reduplication, data retrieval from storage, data uploads into storage and data removal. Data file management is suitably provided via software applications, in a manner which requires very little work to application developers and can be extended to multiple data sources, such as multiple regions having individual storage locations.

By way of further example, the system is suitably implemented via a C# library. A C# library, also known as a class library or assembly, is a collection of pre-written, reusable code components that provide a set of functionalities and services that developers can use in their C# applications. Libraries encapsulate and package code logic, classes, functions, and other resources that can be imported into C# projects, allowing developers to avoid reinventing the wheel and saving time by leveraging existing code.

C# libraries function to promote modularity, code organization, and code reuse. They help programmers create applications more efficiently by providing ready-made solutions for common tasks, such as handling data structures, interacting with databases, performing calculations, working with user interfaces, and much more.

Libraries are suitably developed by individuals, open-source communities, or organizations. They can vary in size from small collections of related utility functions to large frameworks that offer comprehensive sets of tools and features for specific domains. In C#, libraries are compiled into assemblies, which are files containing the compiled code and metadata that describe the contents of the library. These assemblies are suitably distributed and referenced by other projects, enabling integration of the library's functionality into their applications.

Suitable C# libraries include:
.NET Framework Class Library: A comprehensive library provided by Microsoft that offers a wide range of functionalities for building Windows applications.
.NET Core/.NET 5+Standard Libraries: These are cross-platform libraries that provide a common set of APIs for building applications across different platforms.
Entity Framework: A library for object-relational mapping (ORM), making it easier to work with databases using C# code.
Newtonsoft.Json: A popular library for working with JSON data in C# applications.
N Log and log 4net: Libraries for logging and tracing in applications.
SignalR: A library for real-time web functionality, allowing bi-directional communication between client and server.

An example embodiment is provided in connection with a Microsoft Azure environment. Azure is Microsoft's cloud computing platform offering a variety of services for building, deploying, and managing applications and data through the cloud. It encompasses Infrastructure as a Service (IaaS) for virtualized resources, Platform as a Service (PaaS) for streamlined application development, Software as a Service (SaaS) for pre-built applications, and specialized tools for data analytics, AI, IoT, and DevOps. Azure facilitates scaling, cost reduction, and integration of on-premises systems with cloud services.

A library is created that contains a class, suitably referred to as DataDeDuplicatedAzureStorageClient, which is capable of deduplicating an azure blob storage accounts and facilitate insert, read, and delete access to the blob storage in deduplicated manner. The class in this example requires credentials for at least 2 instances of Azure Cloud Storage Accounts (one parent storage, and one child storage) to connect to. The same parent storage account can be used with many children storage accounts, enabling a company to deduplicate their data across multiple storage accounts such as in a case where an application is hosted across multiple regions with multiple storage accounts. Directories and file archives such as zip files containing multiple files will be handled using a recursive depth first search approach to isolate the individual files in the storage.

This method is not limited to C# or to Azure Blob Storage. It can be extended for use with any suitable object-oriented programming languages or in conjunction with other cloud-based file storage systems.

Example embodiments provide an automated data deduplication library which allows businesses to gain the benefits of data deduplication without requiring significant development costs. Data deduplication is suitably expanded to include multiple data sources to further reduce total storage costs, using the concept of a parent storage with multiple children storages. Handling of file archive cases suitably uses a Depth-First Search (DFS) technique. A DFS is a graph traversal algorithm that explores a graph or tree by starting at a chosen node and moving as deeply as possible along each branch before backtracking. It visits nodes, marks them as visited, and explores unvisited neighbors recursively. DFS is used to search paths and detect cycles. DFS is particularly suited for exploration and traversal of interconnected structures.

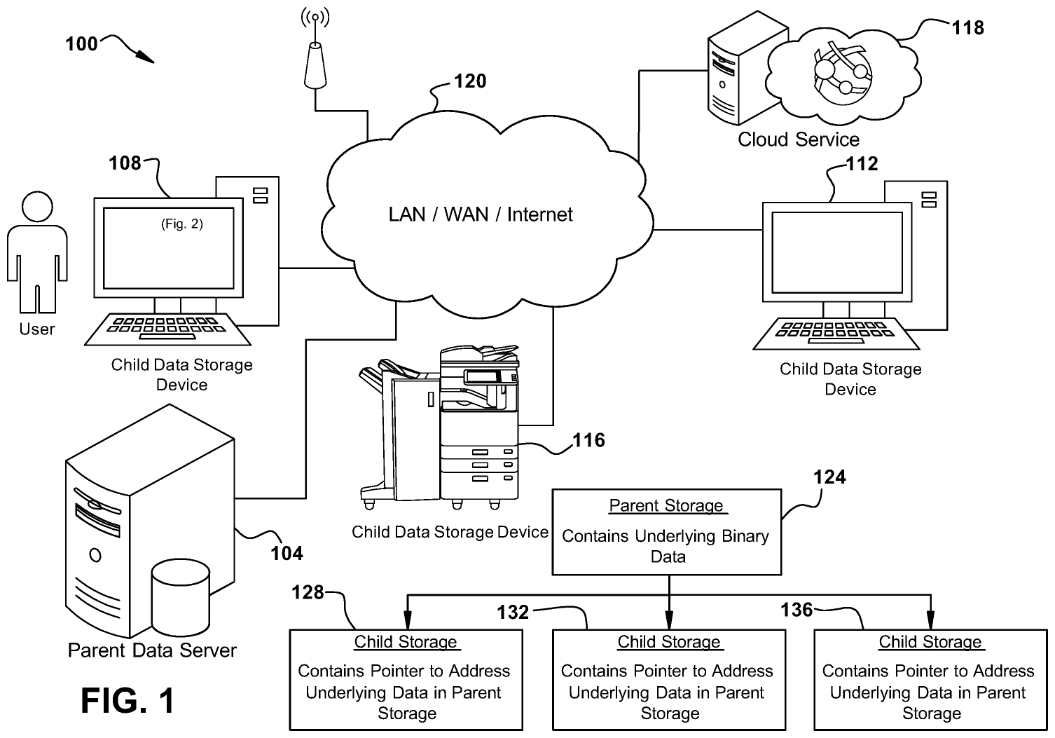

FIG. 1 illustrates an example embodiment of a system 100 for automated data deduplication data management. One or more servers, such as server 104, function as a parent data storage devices. One or more data devices, such as computers 108 and 112, and MFP 116 function as child data storage devices. In the illustrated example, cloud service 118, illustrated as a Microsoft Azure platform, is used for implementation of a data deduplication blob storage client as described in detail below. It is to be appreciated that any suitable local or cloud service is suitably used. In the illustrated example, computer 108 also serves as a gateway device for access to cloud service 118.

Devices are in data communication via network cloud 120, suitably comprised of a local area network (LAN), a wide area network (WAN), which may comprise the Internet, or any suitable combination thereof. Network cloud 120 is comprised of any suitable wireless or wired data connection or combination thereof. As will be detailed below, parent data storage 124 in server 104 includes underlying binary data, suitably hashed blob chunks with each chunk having a unique checksum value. Child data storage 128, 132 and 136 are associated with computers 108, 112 and MFP 116, respectively. Each child storage includes pointers to address underlying data in the parent data storage 124.

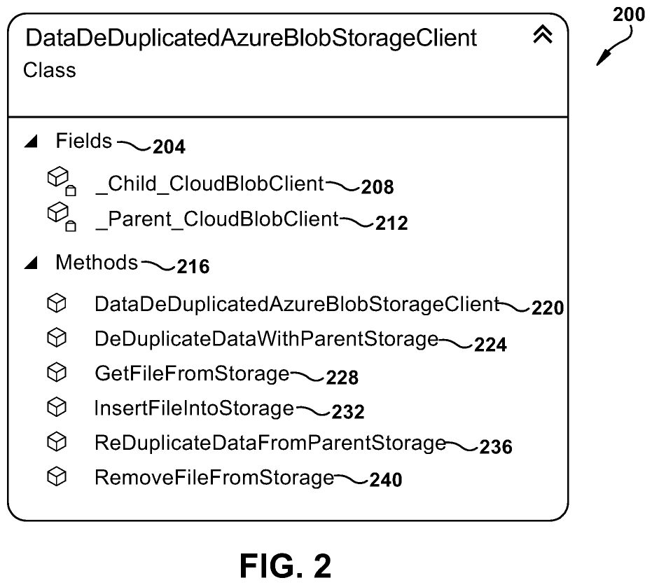

Turning now to FIG. 2, illustrated is an example embodiment of a class diagram 200 for an Azure data deduplication blob storage client. The class diagram is a structural diagram that shows the classes in a system, their attributes, methods, and relationships. Included is field 204 comprising child blob client 208, directed to child data storage devices such as computers 108 and 112 and MFP 116 of FIG. 1 Also included in field 204 is parent blob client 212, directed to parent data storage devices. Methods in class 216 includes data deduplicate Azure blob storage client 220, data deduplicate with parent storage 224, get file from storage client 228, insert file into storage client 232, reduplicate data from parent storage client 236 and remove file from storage client 240. Class and client activity for members of class diagram 200 are detailed below.

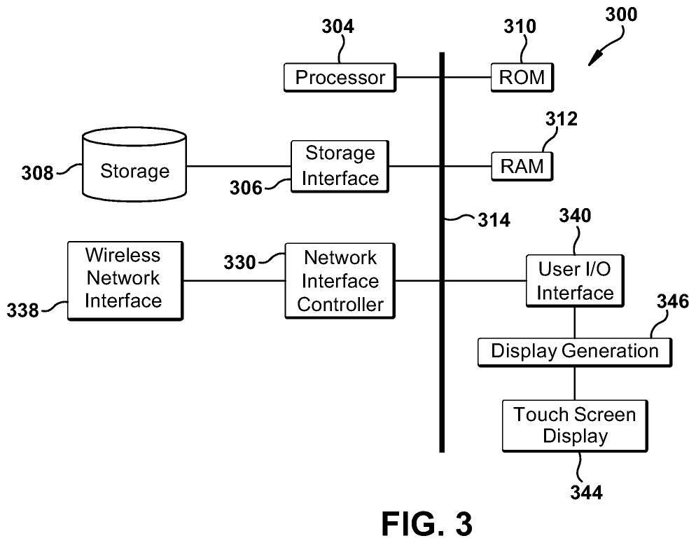

Turning now to FIG. 3, illustrated is an example embodiment of a digital data processing device 300 such as server 104, and computers 108, 112 and MFP 116 of FIG. 1. It is to be noted that MFPs, such as MFP 116, include an intelligent controller that is comprised of a digital computer. It is to be further appreciated that some components listed may be unnecessary in certain configurations. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Data communication among components is accomplished via data bus 314. A network interface controller 330 suitably provides a gateway for data communication with other devices, via any wireless or wired connection, such as via wireless network interface 338. A user input/output interface 340 is suitably comprised of display generator 346 interfacing with touchscreen display 344. As noted above, any suitable user input and display can be used.

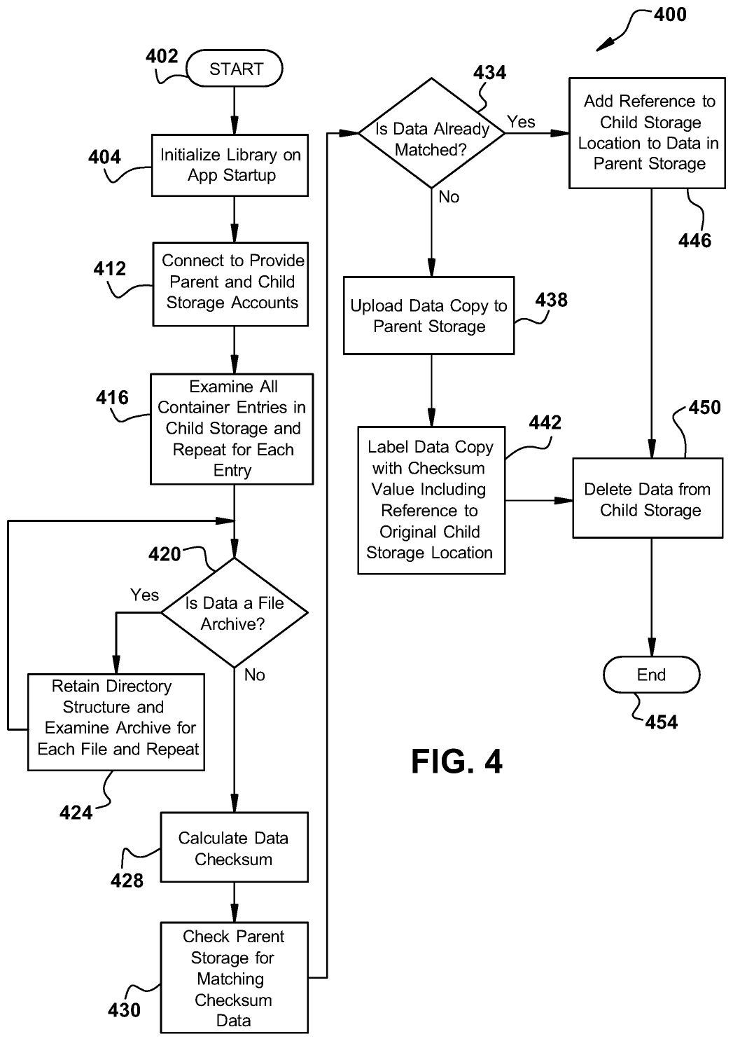

FIG. 4 illustrates a flowchart of an example embodiment of a data deduplication system such as that depicted in the class diagram 200 of FIG. 2 at 220. The process commences at block 402 and proceeds to block 404 where an application is called to initialize a library. Next, a connection is made at block 412 to provide a parent storage account for a parent data server and child storage accounts for child data storage devices. All container entries in each container entry in child storage are checked recursively at block 416. A test is made at block 420 to determine archive files. Archive files are processed recursively at block 424 so as to retain directory structure and then examiner recursively. The process then returns to block 420. Non-archived files are passed to block 428 and an associated checksum is calculated. It is to be appreciated that blobs may be broken into hashed chunks, with a checksum generated for each chunk.

Next, a check is made at block 430 to determine if any matching checksum data is found in parent data storage. A test is then made at block 434 to determine whether there is a match. Next, at block 446, files with matches are added as references to child storage devices pointing to corresponding data stored in parent data storage. Files with no matching checksum are uploaded to parent data storage at block 438. They are then labeled with their checksum value and reference to the original child storage location at block 442. Both block 446 and block 442 proceed to block 450 where data is then deleted from child storage. The process ends at block 454.

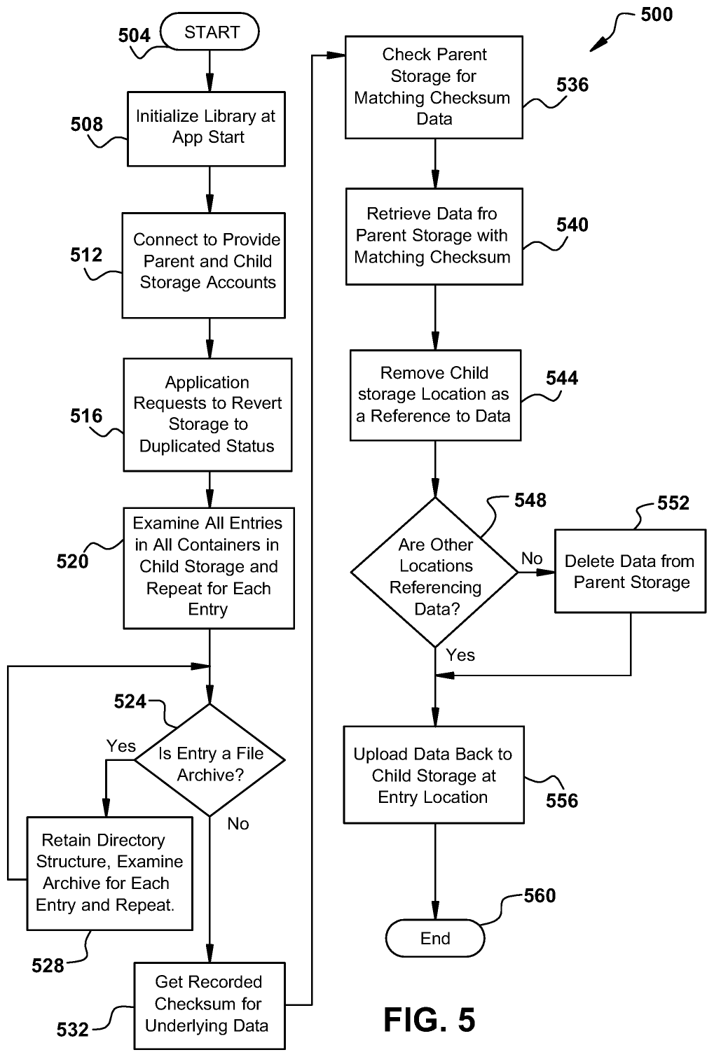

FIG. 5 illustrates a flowchart of an example embodiment of a data reduplication system such as that depicted in the class diagram 200 of FIG. 2 at 236. The process commences at block 504 and proceeds to block 508 where an application is called to initialize a library. Next, a connection is made at block 512 to provide a parent storage account for a parent data server and child storage accounts for child data storage devices. The application initiates a reduplication request at block 516, and proceeds to block 520 where all entries in all containers in child storage is examined recursively. A test is made at block 524 to determine archive entries. Archive entries are processed recursively at block 528 so as to retain directory structure and are examined recursively. The process then returns to block 524. Non-archived entries are passed to block 532 where a checksum for underlying data is recorded.

Next, parent storage is checked for matching checksum data at block 536 and data associated with a matched checksum is retrieved at block 540. Child storage references to parent storage data are then removed at block 544. A test is made as to whether other child locations are referencing the underlying data at block 548. If not, the data is delete from the parent storage at block 552 before proceeding to block 556 where the underlying data is uploaded back to the child storage entry location. If other locations are determined to be referencing the data at block 548, the process proceeds directly to block 556. The process suitably ends at block 560.

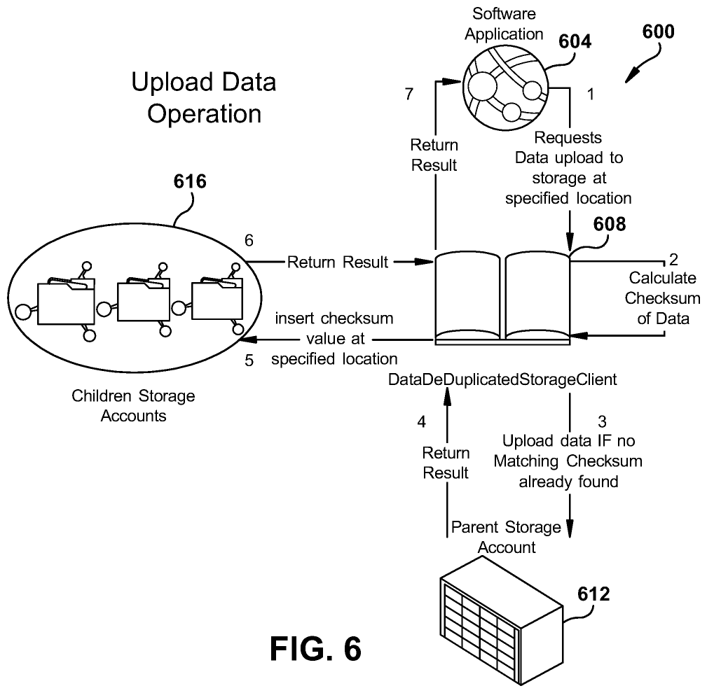

FIG. 6 illustrates a flow diagram of an example embodiment of a data upload system such as that depicted in the class diagram 200 of FIGURE at 228. In the diagram, Azure software application 604 interacts with data deduplication storage client 608 so as to initiate a request to upload data. Data deduplication storage client 608 calculates a checksum for the incoming data. The checksum may be for an entire blob or for segments of a segmented and hashed blob. Whether to segment, and selection of a segment size, are specified to a desired balance between storage space savings and additional computational time. A test is made as to whether calculated checksums exist. If not, the file, along with metadata including the checksum, is uploaded to parent storage 612. The result is communicated from parent storage 612 to data deduplication storage client 608. Checksum information for parent storage data is then relayed to child storage accounts 616, serving as a pointer to access data when needed.

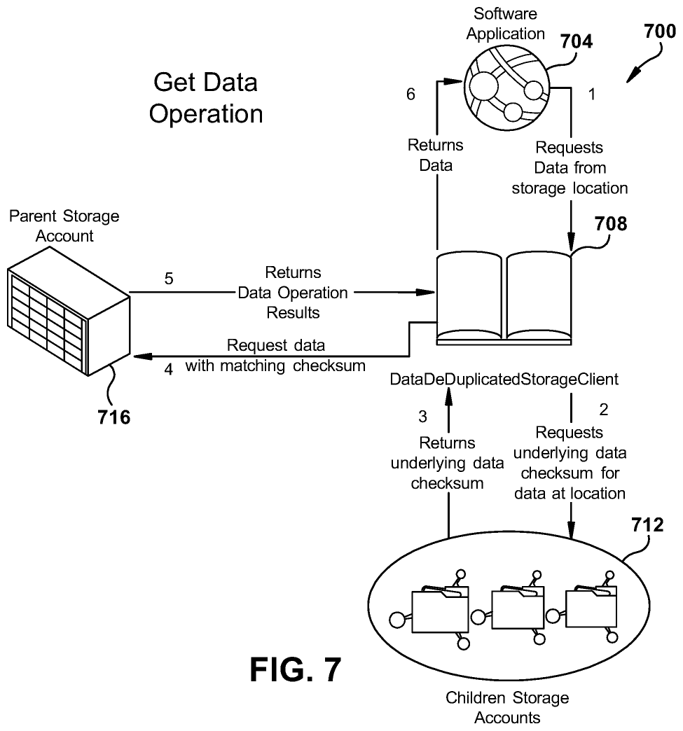

FIG. 7 illustrates a flow diagram of an example embodiment of a data retrieval system such as that depicted in the class diagram 200 of FIG. 2 at 228. In the diagram, Azure software application 704 interacts with data deduplication storage client 708 so as to initiate a request for data from storage. A checksum request for underlying data is then made to child storage accounts 712 which returns an underlying data checksum to data deduplication storage client 708. A request for data, along with its matching checksum, is then made to parent storage account 716 which returns the requested data to data deduplication storage client 708. Data deduplication storage client 708 then relays the data to requesting application 704.

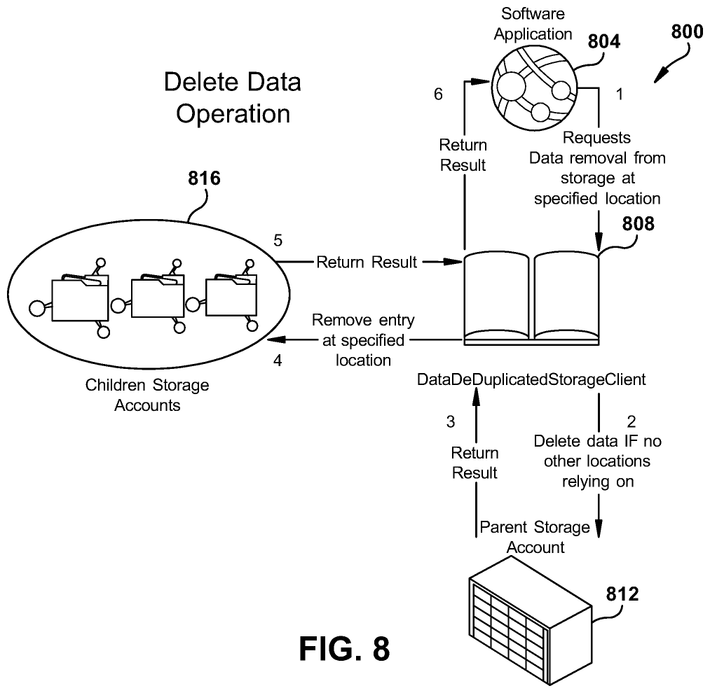

FIG. 8 illustrates a flow diagram of an example embodiment of a data deletion system such as that depicted in the class diagram 200 of FIG. 2. In the diagram, Azure software application 804 interacts with data deduplication storage client 808 so as to initiate a request to remove data from a specified storage location. Client 808 relays the request to parent storage account 812 which will delete the data unless another location maintains a connection to it. The result of the transaction is then communicated back to client 808. Client 808 then directs child storage accounts 816 to remove an associated entry. Child storage accounts then return a result of the transaction to client 808.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

It is claimed:

1. A non-transitory computer readable storage medium storing a program for causing one or more networked computers to execute a data management method including a data deduplication method comprising:
retrieving data entries from a child storage;
calculating checksums for each entry;
storing unique data corresponding to calculated checksums in a parent storage;
replacing each data entry in the child storage with an identifier associated with its checksum;
maintaining a reference file to track the child storage entries referencing unique data;
determining whether data corresponding to any checksum is subject to a single reference; and
for each data entry determined to correspond to a single reference
removing its associated identifier from the child storage, and
uploading its associated data to the child storage.

2. The non-transitory computer readable storage medium of claim 1 wherein the data management method further comprises a data reduplication method comprising:
retrieving checksums from specified child storage entries;
retrieving data corresponding to retrieved checksums from the parent storage;
removing parent storage references and deleting underlying data if no other references to it exist; and
removing retrieved checksums and uploading copies of underlying data to each specified child storage entry.

3. The non-transitory computer readable storage medium of claim 1 wherein the data management method further comprises a get data method comprising:
obtaining checksums from specified child storage;
recursively obtaining checksums for multiple entries in the child storage; and
requesting underlying data from the parent storage using obtained checksums.

4. The non-transitory computer readable storage medium of claim 1 wherein the data management method further comprises an upload data method comprising:
calculating checksums of incoming data;
checking for existence of incoming data in the parent storage;
uploading incoming data to the parent storage and recording associated checksums when the incoming data does not exist in the parent storage; and
recording the associated checksums in the child storage location.

5. The non-transitory computer readable storage medium of claim 1 wherein the data management method further comprises a remove data method comprising:
retrieving checksums from the child storage;
locating data entries in the parent storage in accordance with retrieved checksums;
removing child storage references from parent storage; and
deleting data associated with the located data entries.

6. The non-transitory computer readable storage medium of claim 1 wherein the data management method further includes applying machine learning to dynamically optimize data storage, adapting to usage patterns and minimizing storage redundancy.

7. The non-transitory computer readable storage medium of claim 1 wherein the data management method further includes maintaining a historical record of data access patterns so as to enable predictive analysis to assist future data management decisions and storage allocation utilization.

8. A method comprising:
retrieving checksums from specified child storage entries;
retrieving data corresponding to retrieved checksums from the parent storage;
removing parent storage references and deleting underlying data if no other references to it exist; and
removing retrieved checksums and uploading copies of underlying data to the specified child storage entry;
whereby a data reduplication operation is performed.

9. The method of claim 8 further comprising:
obtaining checksums from specified child storage;
recursively obtaining checksums for multiple entries in the child storage; and
requesting underlying data from the parent storage using obtained checksums.

10. The method of claim 8 further comprising of comprising:
calculating checksums of incoming data;
checking for existence of incoming data in the parent storage;
uploading incoming data to the parent storage and recording associated checksums when the incoming data does not exist in the parent storage; and
recording the associated checksums in the child storage locations.

11. The method of claim 8 further comprising of comprising:
retrieving checksums from the child storage;
locating data entries in the parent storage in accordance with retrieved checksums;
removing child storage references from parent storage; and
deleting data associated with the located data entries.

12. The method of claim 8 further comprising applying machine learning to dynamically optimize data storage, adapting to usage patterns and minimizing storage redundancy.

13. The method of claim 8 further comprising maintaining a historical record of data access patterns so as to enable predictive analysis to assist future data management decisions and storage allocation utilization.

14. A data management system comprising:
a parent data storage server including,
a network interface,
a processor and associated memory;
a parent data storage storing a plurality of data entries, each data entry being associated with a unique checksum;
a plurality of child storage devices, each child storage device including,
a network interface configured for data communication with the parent data storage server,
a processor and associated memory, and
a child data storage storing a plurality of child storage entries and a plurality of data references, wherein each data reference is associated with a data entry and associated checksum in the parent storage;
wherein the parent data storage server is configured to,
connect to each of the child storage devices,
examine each child storage entry,
calculate a checksum for each child storage entry,
determine each calculated checksum that exists in the parent data storage,
for each existing checksum, add a reference to a parent data entry associated with the existing checksum in the associated child storage location;
when the calculated checksum does not exist, store a copy of the child storage entry and associated checksum in the parent data storage; and
delete the child storage entry from the child data storage.

15. The data management system of claim 14 wherein the parent data storage server is further configured to:
retrieve checksums from specified child storage entries;
retrieve data entries corresponding to retrieved checksums from the parent data storage;
remove each storage references and underlying data if no other references to it exist; and
remove retrieved checksums and store copies of underlying data to each specified child storage entry.

16. The data management system of claim 15 wherein each child storage device is further configured to:
recursively obtain checksums for multiple entries in its child storage; and
request underlying data from the parent data storage using obtained checksums.

17. The data management system of claim 16 wherein each child data device is further configured to:
calculate checksums of incoming data;
check for existence of the incoming data in the parent data storage;
upload incoming data to the parent data storage and record associated checksums when the incoming data does not exist in the parent data storage; and
record the associated checksums in its child data storage location.

18. The data management system of claim 17 wherein the parent data storage server is further configured to:
receive checksums from each child storage;
locate data entries in the parent data storage in accordance with retrieved checksums;
send the data entries to each child storage corresponding to received checksums;
delete child storage references from the parent storage; and
delete data associated with the located data entries from the parent data storage.

19. The data management system of claim 18 wherein the parent data storage server is further configured to apply machine learning to dynamically optimize data storage, adapting to usage patterns and minimizing storage redundancy.

20. The data management system of claim 18 wherein the parent data storage is further configured to maintain a historical record of data access patterns and apply predictive analysis for future data management decisions.
